(19) United States
(12) Patent Application Publication
(10) Pub. No.: US 2023/0419880 A1
(43) Pub. Date: Dec. 28, 2023

(54) DRIVER CHIP, DISPLAY PANEL, AND DRIVING METHOD THEREOF

(71) Applicant: TCL CHINA STAR OPTOELECTRONICS TECHNOLOGY CO., LTD., Shenzhen, Guangdong (CN)

(72) Inventor: Haoran LI, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/274,801

(22) PCT Filed: Dec. 29, 2020
(86) PCT No.: PCT/CN2020/141072

§ 371 Date: Sep. 5, 2023

(30) Foreign Application Priority Data
Dec. 23, 2020 (CN) 202011550600.7

(51) Int. Cl. G09G 3/32

(52) U.S. Cl. CPC G09G 3/32; G09G 2320/0633; G09G 2320/0271

(57) ABSTRACT

A driver chip, a display panel, and a driving method thereof are provided. The driver chip uses a pulse width modulation module and a pulse amplitude modulation module to control a waveform and a strength of a data signal respectively, which can obtain more display grayscales, a to-be-displayed brightness of a light emitting unit is larger, and a gradation level of the light-emitting unit is better. The pulse amplitude modulation module can modulate the strength of the data signal, can compensate the pixels, and improve the display quality of the display panel.

### FIELD OF INVENTION

The present disclosure relates to the technical field of display, and in particular, relates to a driver chip, a display panel, and a driving method thereof.

### BACKGROUND OF INVENTION

In order to achieve an improved display effect, in an existing display panel, mini-LED device may be used as a display light source. The brightness of the mini-LED device is adjusted by a pulse width modulation circuit to realize the display of different gray scales of a display panel. However, in the driving process of the display panel, due to a parasitic capacitance of a transistor and a voltage drop of wiring of the display panel, the turn-on time of the transistor is insufficient. The charging time of the light-emitting diodes is relatively short, which results in poor adjustment capability of the pulse width modulation circuit, so that the gray scale of the display panel is low, and the display quality of the display panel is poor.

Therefore, the existing display panel has a technical problem that the poor adjustment capability of the pulse width modulation capability results in the poor display quality of the display panel.

### SUMMARY OF INVENTION

### Technical Problem

The present disclosure provides a driver chip, a display panel, and a driving method thereof, which solve the technical problem that poor adjustment ability of a pulse width modulation ability of an existing display panel leads to poor display quality of a display panel.

### TECHNICAL SOLUTION TO TECHNICAL PROBLEM

### Technical Solution

To solve the above problems, the technical solutions provided by the present disclosure are as follows:

An embodiment of the present disclosure provides a driver chip, which includes:
a data signal input module connected to a transistor of a pixel for inputting a data signal into the transistor;
a pulse width modulation module connected to the data signal input module for outputting a waveform corresponding to the data signal to the data signal input module according to a to-be-displayed brightness of the pixel; and
a pulse amplitude modulation module connected to the data signal input module for outputting a strength corresponding to the data signal to the data signal input module according to a to-be-displayed brightness of the pixel;

wherein the data signal input module is configured to process the waveform corresponding to the data signal and the strength corresponding to the data signal to obtain the data signal after receiving the waveform corresponding to the data signal and the strength corresponding to the data signal.

In some embodiments, a number of bits of the pulse width modulation module is equal to or greater than a number of bits of the pulse amplitude modulation module.

In some embodiments, the number of bits of the pulse width modulation module is 7, and the number of bits of the pulse amplitude modulation module is 5.

In some embodiments, the driver chip further comprises a grayscale module, the grayscale module is configured to determine a maximum display grayscale of the pixel according to the bits of the pulse width modulation module and the bits of the pulse amplitude modulation module and determine the waveform corresponding to the data signal outputted from the pulse width modulation module and the strength corresponding to the data signal outputted from the pulse amplitude modulation module at each display grayscale according to the maximum display grayscale of the pixel.

In some embodiments, the driver chip further comprises a signal acquisition module, the signal acquisition module is configured to determine a to-be-displayed grayscale of the pixel according to the to-be-displayed brightness of the pixel and send an acquisition signal to the grayscale module according to the to-be-displayed grayscale, and the grayscale module is configured to return the waveform corresponding to the data signal outputted from the pulse width modulation module and the strength corresponding to the data signal outputted from the pulse amplitude modulation module to the signal acquisition module after receiving the acquisition signal.

In some embodiments, a number of bits of the pulse amplitude modulation module is greater than a number of bits of the pulse width modulation module.

In some embodiments, the number of bits of the pulse amplitude modulation module is 8, and the number of bits of the pulse width modulation module is 7.

In some embodiments, the driver chip further comprises a parasitic capacitance, the pulse amplitude modulation module is configured to output the strength corresponding to a compensation data signal when the pixel is not displayed according to a value of the parasitic capacitance, and the pulse width modulation module is configured to output the waveform corresponding to the compensation data signal when the pixel is not displayed according to the value of the parasitic capacitance.

At the same time, an embodiment of the present disclosure provides a display panel including a driver chip and pixels arranged in an array, wherein the driver chip includes:
a data signal input module connected to a transistor of one of the pixel for inputting a data signal into the transistor;
a pulse width modulation module connected to the data signal input module for outputting a waveform corresponding to the data signal to the data signal input module according to a to-be-displayed brightness of the pixel; and
a pulse amplitude modulation module connected to the data signal input module for outputting a strength corresponding to the data signal to the data signal input module according to a to-be-displayed brightness of the pixel;
wherein the data signal input module is configured to process the waveform corresponding to the data signal and the strength corresponding to the data signal to obtain the data signal after receiving the waveform corresponding to the data signal and the strength corresponding to the data signal.

In some embodiments, a number of bits of the pulse width modulation module is equal to or greater than a number of bits of the pulse amplitude modulation module.

In some embodiments, the number of bits of the pulse width modulation module is 7, and the number of bits of the pulse amplitude modulation module is 5.

In some embodiments, the driver chip further comprises a grayscale module, the grayscale module is configured to determine a maximum display grayscale of the pixel according to the bits of the pulse width modulation module and the bits of the pulse amplitude modulation module and determine the waveform corresponding to the data signal outputted from the pulse width modulation module and the strength corresponding to the data signal outputted from the pulse amplitude modulation module at each display grayscale according to the maximum display grayscale of the pixel.

In some embodiments, the driver chip further comprises a signal acquisition module, the signal acquisition module is configured to determine a to-be-displayed grayscale of the pixel according to the to-be-displayed brightness of the pixel and send an acquisition signal to the grayscale module according to the to-be-displayed grayscale, and the grayscale module is configured to return the waveform corresponding to the data signal outputted from the pulse width modulation module and the strength corresponding to the data signal outputted from the pulse amplitude modulation module to the signal acquisition module after receiving the acquisition signal.

In some embodiments, a number of bits of the pulse amplitude modulation module is greater than a number of bits of the pulse width modulation module.

In some embodiments, the driver chip further comprises a parasitic capacitance, the pulse amplitude modulation module is configured to output the strength corresponding to a compensation data signal when the pixel is not displayed according to a value of the parasitic capacitance, and the pulse width modulation module is configured to output the waveform corresponding to the compensation data signal when the pixel is not displayed according to the value of the parasitic capacitance.

In some embodiments, the display panel includes a power terminal, a light emitting unit, a driving transistor, and a switching transistor, the driver chip includes a scanning signal input module, the power terminal is electrically connected to an anode of the light emitting unit, a cathode of the light emitting unit is electrically connected to a first electrode of the driving transistor, a second electrode of the driving transistor is electrically connected to the ground, a gate of the driving transistor is electrically connected to a second electrode of the switching transistor, a first electrode of the switching transistor is electrically connected to the data signal input module, and a gate of the switching transistor is electrically connected to the scanning signal input module.

At the same time, an embodiment of the present disclosure provides a driving method of display panel, comprising steps of:
acquiring a to-be-displayed image of a display panel;
determining a to-be-displayed brightness of each pixel according to the to-be-displayed image of the display panel;
determining a display grayscale corresponding to the to-be-displayed brightness of each pixel according to the to-be-displayed brightness of each pixel;
determining a data signal corresponding to the display grayscale according to the display grayscale corresponding to the to-be-displayed brightness of each pixel;
determining a waveform and a strength corresponding to the data signal according to the data signal corresponding to the display grayscale; and
actuating a pulse width modulation module and a pulse amplitude modulation module of the driver chip to output the waveform corresponding to the data signal and the strength corresponding to the data signal respectively for displaying the to-be-displayed image.

In some embodiments, before the step of acquiring the to-be-displayed image of the display panel, the driving method further comprises steps of:
acquiring the bits of the pulse width modulation module;
acquiring the bits of the pulse amplitude modulation module;
determining a maximum display grayscale of each pixel according to the bits of the pulse width modulation module and the bits of the pulse amplitude modulation module;
determining the waveform corresponding to the data signal outputted from the pulse width modulation module and the strength corresponding to the data signal outputted from the pulse amplitude modulation module at each display grayscale according to the maximum display grayscale of each pixel.

In some embodiments, the step of determining the waveform corresponding to the data signal outputted from the pulse width modulation module and the strength corresponding to the data signal outputted from the pulse amplitude modulation module at each display grayscale according to the maximum display grayscale of each pixel comprises:
determining a type of the waveform corresponding to the data signal according to the bits of the pulse width modulation module;
determining a type of the strength corresponding to the data signal according to the bits of the pulse amplitude modulation module; and
determining the waveform corresponding to the data signal outputted from the pulse width modulation module and the strength corresponding to the data signal outputted from the pulse amplitude modulation module at each display grayscale according to the type of the waveform corresponding to the data signal and the type of the strength corresponding to the data signal.

In some embodiments, before the step of acquiring the to-be-displayed image of the display panel, the driving method further comprises steps of:
acquiring a value of a parasitic capacitance of the pixel when the pixel is not displayed;
determining a waveform corresponding to a compensation data signal of the pixel and a strength corresponding to the compensation data signal of the pixel according to the value of the parasitic capacitance; and
actuating the pulse width modulation module and the pulse amplitude modulation module to output the strength corresponding to the compensation data signal respectively.

### BENEFICIAL EFFECTS OF PRESENT DISCLOSURE

### Beneficial Effects

The present disclosure provides a driver chip, a display panel, and a driving method thereof. The driver chip includes a data signal input module, a pulse width modulation module, and a pulse amplitude modulation module. The data signal input module is connected to a transistor of a pixel for inputting a data signal into the transistor. The pulse width modulation module is connected to the data signal input module for outputting a waveform corresponding to the data signal to the data signal input module according to a to-be-displayed brightness of the pixel. The pulse amplitude modulation module is connected to the data signal input module for outputting a strength corresponding to the data signal to the data signal input module according to a to-be-displayed brightness of the pixel. The data signal input module is configured to process the waveform corresponding to the data signal and the strength corresponding to the data signal to obtain the data signal after receiving the waveform corresponding to the data signal and the strength corresponding to the data signal. The embodiments of the present disclosure uses the pulse width modulation module and the pulse amplitude modulation module to control the waveform and strength of the data signal, respectively. Under the common control of the pulse width modulation module and the pulse amplitude modulation module, more display grayscales can be obtained, the to-be-displayed brightness of the light-emitting unit is larger, and the gradation level of the light-emitting unit is better. Moreover, the pulse amplitude modulation module can modulate the strength of the data signal and compensate the pixels, thereby improving the display quality of the display panel.

### BRIEF DESCRIPTION OF DRAWINGS OF PRESENT DISCLOSURE

### Description of Drawings

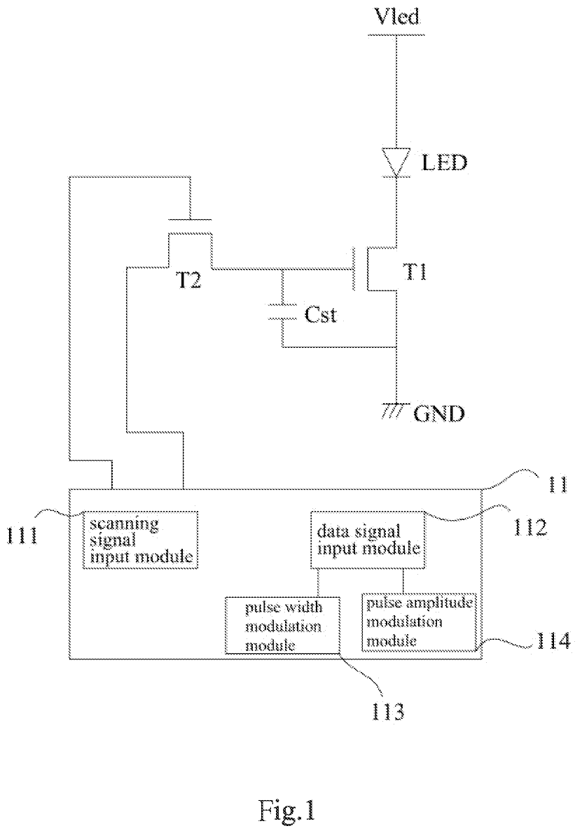

FIG. 1 is a schematic diagram of a display panel according to an embodiment of the present disclosure.

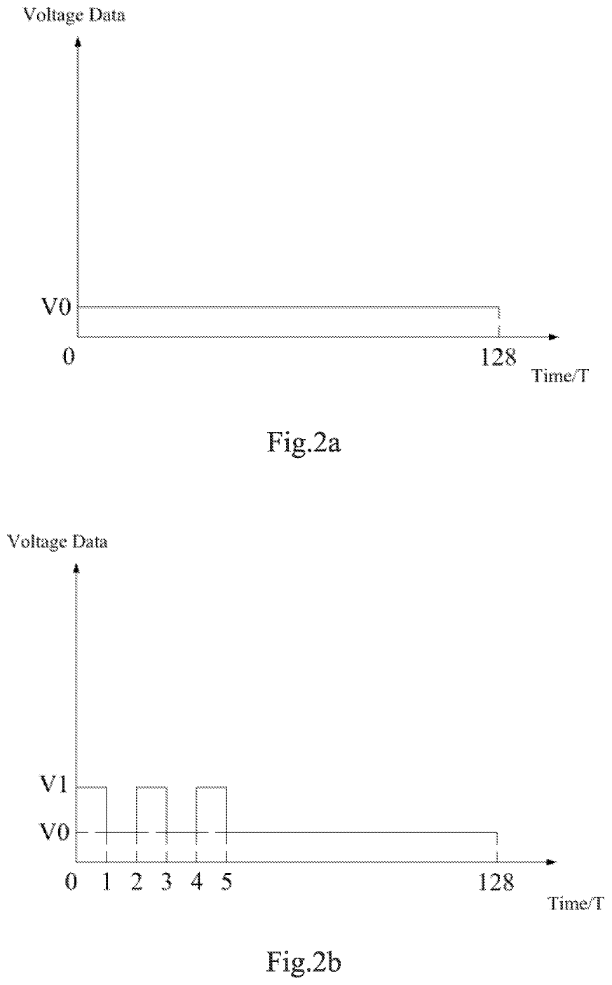

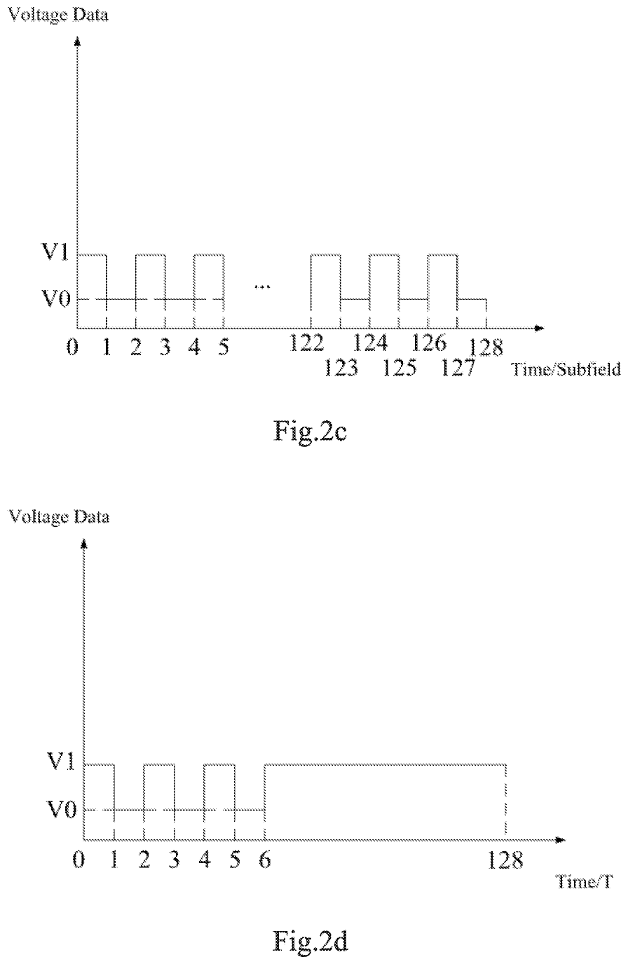

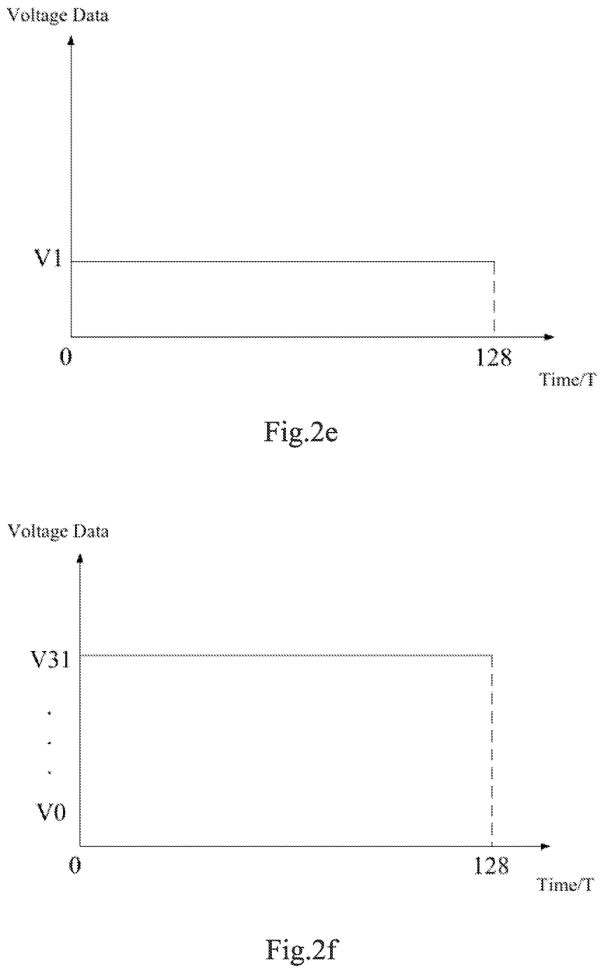

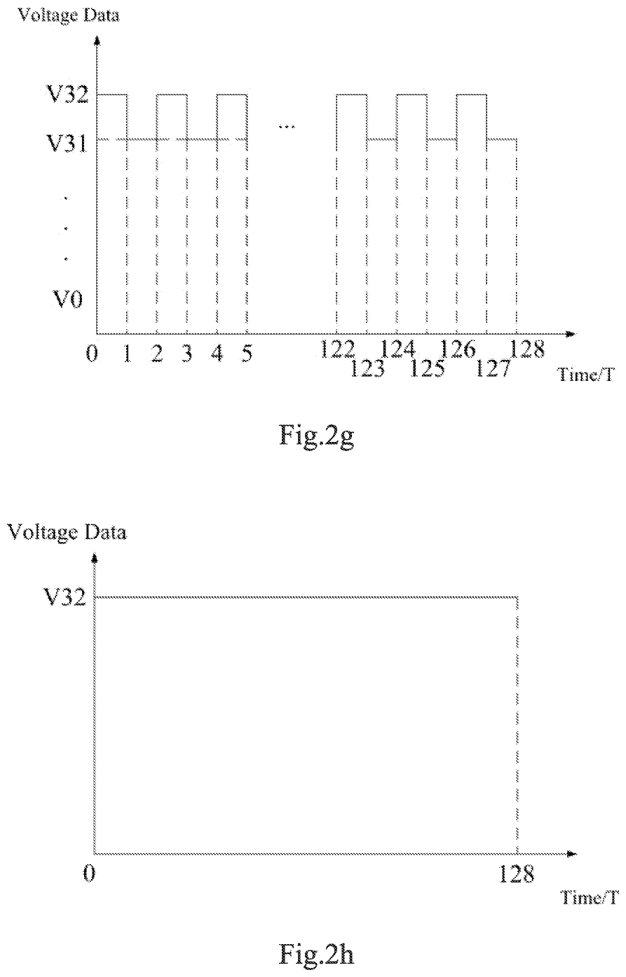

FIG. 2a is a graph of the voltage data at grayscale 0 of the display panel according to an embodiment of the present disclosure.

FIG. 2b is a graph of the voltage data at grayscale 3 of the display panel according to an embodiment of the present disclosure.

FIG. 2c is a graph of the voltage data at grayscale 64 of the display panel according to an embodiment of the present disclosure.

FIG. 2d is a graph of the voltage data at grayscale 125 of the display panel according to an embodiment of the present disclosure.

FIG. 2e is a graph of the voltage data at grayscale 128 of the display panel according to an embodiment of the present disclosure.

FIG. 2f is a graph of the voltage data at grayscale 3968 of the display panel according to an embodiment of the present disclosure.

FIG. 2g is a graph of the voltage data at grayscale 4032 of the display panel according to an embodiment of the present disclosure.

FIG. 2h is a graph of the voltage data at grayscale 4096 of the display panel according to an embodiment of the present disclosure.

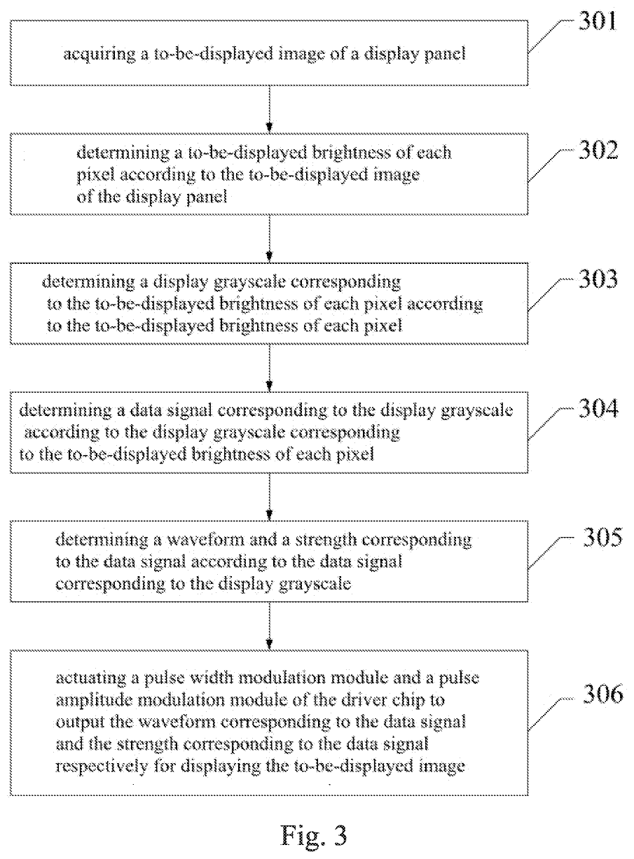

FIG. 3 is a flowchart of a driving method of a display panel according to an embodiment of the present disclosure.

### DETAILED DESCRIPTION OF PREFERRED EMBODIMENTS

### Embodiments of the Present Disclosure

The present disclosure provides a driver chip, a display panel, and a driving method thereof. In order to make the purpose, technical solutions and effects of the present disclosure clearer, the following further describes the present disclosure in detail with reference to the drawings and embodiments. It should be understood that the specific embodiments described here are only used to explain the application, and not used to limit the present disclosure.

The embodiments of the present disclosure address the technical problem that the poor adjustment ability of the pulse width modulation capability of the existing display panel leads to poor display quality of the display panel. The present disclosure is used to solve the technical problem.

Refer to FIG. 1. An embodiment of the present disclosure provides a driver chip, and the driver chip 11 includes:
a data signal input module 112 connected to a transistor of a pixel for inputting a data signal into the transistor;
a pulse width modulation module 113 connected to the data signal input module 112 for outputting a waveform corresponding to the data signal to the data signal input module 112 according to a to-be-displayed brightness of the pixel; and
a pulse amplitude modulation module 114 connected to the data signal input module 112 for outputting a strength corresponding to the data signal to the data signal input module 112 according to a to-be-displayed brightness of the pixel;
wherein the data signal input module 112 is configured to process the waveform corresponding to the data signal and the strength corresponding to the data signal to obtain the data signal after receiving the waveform corresponding to the data signal and the strength corresponding to the data signal.

The embodiment of the present disclosure provides a driver chip, which outputs the waveform and the strength of the data signal through the pulse width modulation module and the pulse amplitude modulation module respectively. Under the common control of the pulse width modulation module and the pulse amplitude modulation module, more display grayscales can be obtained, the brightness of the light emitting unit to be displayed is more, the gradation level of the light emitting unit is better, and the pulse amplitude modulation module can modulate the strength of the data signal, compensate the pixels, and improve the display quality of the display panel.

In one embodiment, a number of bits of the pulse width modulation module is equal to or greater than a number of bits of the pulse amplitude modulation module. For example, the number of bits of the pulse width modulation module is 7, and the number of bits of the pulse amplitude modulation module is 5. In the process of adjusting the brightness of the light emitting unit of the pixel, the adjustment of the waveform of the data signal of the light emitting unit is simpler than the adjustment of the strength of the data signal of the light emitting unit. The waveform of the data signal can be controlled by time control to control the accuracy, and the strength of the data signal may be affected by factors, such as ambient temperature, routing design, and voltage fluctuations, making the strength of the data signal relatively difficult to control. Therefore, the bits of the pulse width modulation module are made larger than the bits of the pulse amplitude modulation module, so that it is easy to adjust the data signal of the display panel through the pulse width modulation module and the pulse amplitude modulation module.

In one embodiment, the bits of the pulse width modulation module may be limited by the existing technology, including but not limited to the parasitic capacitance of the transistors, the voltage drop of the wiring, etc., so that the bits of the pulse width modulation module cannot be increased. Therefore, the bits of the pulse amplitude modulation module can be made larger than the bits of the pulse width modulation module. Specifically, for example, the number of bits of the pulse amplitude modulation module is 8 and the number of the bits of the pulse width modulation module is 7, even if the number of the bits of the pulse width modulation module are only 7 can be achieved in the existing technology. Furthermore, by increasing the bits of the pulse amplitude modulation module, the grayscale of the display panel can be further increased, thereby improving the display quality of the display panel.

In one embodiment, the driver chip further comprises a grayscale module, and the grayscale module is configured to determine a maximum display grayscale of the pixel according to the bits of the pulse width modulation module and the bits of the pulse amplitude modulation module and determine the waveform corresponding to the data signal outputted from the pulse width modulation module and the strength corresponding to the data signal outputted from the pulse amplitude modulation module at each display grayscale according to the maximum display grayscale of the pixel. That is, it is assumed that the number of the bits of the pulse width modulation module is 7, and the number of the bits of the pulse amplitude modulation module is 5. At this time, the maximum bit that the pulse width modulation module and the pulse amplitude modulation module can reach is 12, and the maximum display grayscale of the pixel is the 12th power of 2, that is, grayscale 4096. When the display grayscale is reached, the waveform of the data signal output by the pulse width modulation module continues to be a straight line, and the strength of the data signal output by the pulse amplitude modulation module is the maximum value, so that the pixel displays the maximum display grayscale. The output signal of the pulse width modulation module and the output signal of the pulse amplitude modulation module corresponding to each display grayscale are determined according to the maximum display grayscale and the output signals of the pulse width modulation module and the pulse amplitude modulation module. Specifically, an example is as follows. It is assumed that the number of the bits of the pulse width modulation module is 7, and the number of the bits of the pulse amplitude modulation module is 5. Since the number of the bits of the pulse amplitude modulation module is 5, it can be obtained that the output signal of the pulse amplitude modulation module is up to the 5th power of 2, that is, 32 kinds of voltage data. At the same time, considering the compensation voltage, adding a set of V0 data, 33 kinds of voltage data can be obtained, and the number of the bits of the pulse width modulation module is 7, then the number of subfields of the pulse width modulation module is 128. The pulse width modulation module can output up to the 7th power of 2, that is, 128 waveforms. Each subfield corresponds to a waveform, as shown in FIG. 2a to FIG. 2h, a frame is divided into 128 time periods, the abscissa is time, the unit is T, the ordinate is the voltage data, and the voltage data are V0 from small to large, such as V1, V2, . . . , V32. FIG. 2a is a graph of voltage data corresponding to grayscale 0 when the pixel is not displayed. At this time, the waveform of the voltage data output by the pulse width modulation module is a straight line, and the strength of the voltage data output by the pulse amplitude modulation module is V0. The voltage is less than the threshold voltage of the transistor, the transistor is not turned on, so that the light emitting unit does not emit light. FIG. 2b is a graph of voltage data corresponding to grayscale 3. As shown in FIG. 2b, in the waveform of the voltage data output by the pulse width modulation module, there are three time periods at high potential, and other time periods at low potential. The high potential of the voltage data output by the pulse amplitude modulation module is V1, and the low potential is V0. FIG. 2b shows that the first time period from 0 to 1T time point, the third time period from 2T time point to 3T time point, and the fifth time period from 4T time point to 5T time point are high, and the rest time periods are low. FIG. 2c is a graph of voltage data corresponding to grayscale 64. In the waveform of the voltage data output by the pulse width modulation module, there are 64 time periods at a high level and 64 time periods at a low level. The high level of the voltage data output by the pulse amplitude modulation module is V1 and the low level is V0. The time period at high potential and the time period at low potential appear at intervals. As shown in FIG. 2c, the first time period from 0 to 1T time point is the high potential, and then the low potential, the high potential, the low potential, the high potential, . . . , the low potential, the high potential, and the low potential. Each appearing 64 times to obtain the output signal of the pulse width modulation module and the output signal of the pulse amplitude modulation module when the display grayscale is grayscale 64. FIG. 2d is a graph of voltage data corresponding to grayscale 125. In the waveform of the voltage data output by the pulse width modulation module, there are three time periods at a low level, and the rest the time periods at a high level. FIG. 2d shows that the second time period from 1T time point to 2T time point, the fourth time period from 3T time point to 4T time point, and the 6th time period from 5T time point to 6T time point are low potential, the rest time periods are at high potential, the high potential of the voltage data output by the pulse amplitude modulation module is V1, and the low potential is V0, so that the display panel displays grayscale 125. As shown in FIG. 2e, at the 128th grayscale, the waveform of the voltage data output by the pulse width modulation module is a straight line, and the strength of the voltage data output by the pulse amplitude modulation module is V1, and the waveform of the voltage data output by the pulse width modulation module of other grayscales and the magnitude of the voltage data output by the pulse amplitude modulation module are obtained accordingly. As shown in FIG. 2f, at the grayscale 3968, the waveform of the voltage data output by the pulse width modulation module is a straight line, and the strength of the voltage data output by the pulse amplitude modulation module is V31. As shown in FIG. 2g, when the grayscale is grayscale 4032, the waveform of the voltage data output by the pulse width modulation module have 64 time periods at high potential and 64 time periods at low potential. At this time, the high potential of the voltage data output by the pulse amplitude modulation module is V32, and the low potential is V31. As shown in FIG. 2h, the waveform of the voltage data output by the pulse width modulation module is a straight line, and the strength of the voltage data output by the pulse amplitude modulation module is V32. It can be seen from the waveforms of the voltage data of different grayscales and the difference between the high potential and the low potential of the voltage data in FIG. 2a to FIG. 2h. The waveform and strength of the data signal are respectively controlled by the pulse width modulation module and the pulse amplitude modulation module. When the number of bits of the pulse width modulation module is 7 and the number of bits of the pulse amplitude modulation module is 5, the display of grayscale 4096 can be realized. Compared with the prior art, due to the influence of the existing parasitic capacitance and voltage drop, the maximum number of bits of the pulse width modulation module is 7, which can only achieve the display of grayscale 128. The embodiments of the present disclosure increase the number of display grayscale, so that during the display process, the gradation level of the light emitting unit is improved, thereby improving the display quality of the display panel.

In FIG. 2a to FIG. 2h, it should be noted that the time period T is taken as a unit, which means that the time interval between adjacent time points is 1 time period T. A frame is divided into 128 time periods at equal intervals, and the waveform of the data signal output by the pulse width modulation module is obtained by displaying high or low potentials in different time periods. The strength of the data signal output by the pulse width modulation module is obtained through the control of the voltage magnitude of the high potential and the low potential, thereby obtaining data signals of different display grayscales.

It should be noted that, in the embodiment of the present disclosure, one cycle can also be divided into 128 time periods. For a column of pixels, when voltage data are input to a column of pixels in a frame, the voltage data input to each pixel is the voltage data in the above embodiment. When the data signal of each pixel is input, the data signal is the data signal of which the pulse width modulation module and the pulse amplitude modulation module jointly control the output, so that the light emitting unit of each pixel can reach grayscale 4096, thereby improving the display quality.

In FIG. 2a to FIG. 2h, when the waveform of the voltage data output by the pulse width modulation module includes a high potential and a low potential, the embodiment sets the high potential and the low potential at intervals. In the actual driving process, there can be a continuous high potential and then a continuous low potential, or a high potential and a low potential without a fixed interval. It is only required to make the number of high potentials and the number of low potentials in the voltage data output by the pulse width modulation module meet the requirements. For example, in the grayscale 125, there are 3 low potentials, and the time and interval of the 3 low potentials can be set according to requirements. In the embodiment of the present disclosure, the output voltage data can be further stablized, and the display effect can be improved by appearing the high potential and the low potential at equal intervals.

It should be noted that the embodiment of the present disclosure uses the voltage data as the data signal, but the embodiment of the present application is not limited.

In one embodiment, the driver chip further comprises a signal acquisition module, the signal acquisition module is configured to determine a to-be-displayed grayscale of the pixel according to the to-be-displayed brightness of the pixel and send an acquisition signal to the grayscale module according to the to-be-displayed grayscale. The grayscale module is configured to return the waveform corresponding to the data signal outputted from the pulse width modulation module and the strength corresponding to the data signal outputted from the pulse amplitude modulation module to the signal acquisition module after receiving the acquisition signal. When the pixel is displayed, the to-be-displayed grayscale of the pixel needs to be determined according to the to-be-displayed brightness of the pixel. The waveform of the data signal output by the pulse width modulation module and the strength of the data signal output by the pulse amplitude modulation module are determined through the to-be-displayed grayscale from the grayscale module. Signals are sent to the pulse width modulation module and the pulse amplitude modulation module through the signal acquisition module. After the signal acquisition module receives the to-be-displayed brightness of the pixel, the waveform of the data signal corresponding to the to-be-displayed brightness and the strength of the data signal can be determined through the grayscale module, and the data signal input module correspondingly outputs the data signal corresponding to the to-be-displayed brightness, so as to achieve pixel display.

In one embodiment, the driver chip further comprises a parasitic capacitance, the pulse amplitude modulation module is configured to output the strength corresponding to a compensation data signal when the pixel is not displayed according to a value of the parasitic capacitance, and the pulse width modulation module is configured to output the waveform corresponding to the compensation data signal when the pixel is not displayed according to the value of the parasitic capacitance. There is parasitic capacitance in the driving circuit of the pixel. When the driver chip outputs the data signal, the parasitic capacitance is compensated, which can improve the display effect of the pixel. Therefore, when the data signal input module inputs the data signal, the corresponding compensation data signal can be input to the pixel when the pixel is not displayed. When the pixel emits light, the interference of the parasitic capacitance can be removed. The to-be-displayed brightness can be sent out according to the data signal to improve the display quality.

In one embodiment, as shown in FIG. 1, an embodiment of the present disclosure provides a display panel. The display panel includes a driver chip 11 and pixels arranged in an array. The driver chip 11 includes:
a data signal input module 112 connected to a transistor of a pixel for inputting a data signal into the transistor;
a pulse width modulation module 113 connected to the data signal input module 112 for outputting a waveform corresponding to the data signal to the data signal input module 112 according to a to-be-displayed brightness of the pixel; and
a pulse amplitude modulation module 114 connected to the data signal input module 112 for outputting a strength corresponding to the data signal to the data signal input module 112 according to a to-be-displayed brightness of the pixel;
wherein the data signal input module 112 is configured to process the waveform corresponding to the data signal and the strength corresponding to the data signal to obtain the data signal after receiving the waveform corresponding to the data signal and the strength corresponding to the data signal.

An embodiment of the present disclosure provides a display panel including a driver chip and pixels arranged in an array. The waveform of the corresponding data signal and the strength of the data signal are output to each pixel through the pulse width modulation module and the pulse amplitude modulation module. When the display panel displays the image, each pixel can display more grayscales, so that the display panel can display more levels of the image. Since the pulse amplitude modulation module can modulate the strength of the data signal, the pixels are compensated, and the display quality of the display panel is improved.

In one embodiment, in the display panel, a number of bits of the pulse width modulation module is equal to or greater than a number of bits of the pulse amplitude modulation module.

In one embodiment, in the display panel, the number of bits of the pulse width modulation module is 7, and the number of bits of the pulse amplitude modulation module is 5.

In one embodiment, in the display panel, the driver chip further comprises a grayscale module, the grayscale module is configured to determine a maximum display grayscale of the pixel according to the bits of the pulse width modulation module and the bits of the pulse amplitude modulation module and determine the waveform corresponding to the data signal outputted from the pulse width modulation module and the strength corresponding to the data signal outputted from the pulse amplitude modulation module at each display grayscale according to the maximum display grayscale of the pixel.

In one embodiment, in the display panel, the driver chip further comprises a signal acquisition module, the signal acquisition module is configured to determine a to-be-displayed grayscale of the pixel according to the to-be-displayed brightness of the pixel and send an acquisition signal to the grayscale module according to the to-be-displayed grayscale, and the grayscale module is configured to return the waveform corresponding to the data signal outputted from the pulse width modulation module and the strength corresponding to the data signal outputted from the pulse amplitude modulation module to the signal acquisition module after receiving the acquisition signal.

In one embodiment, in the display panel, a number of bits of the pulse amplitude modulation module is greater than a number of bits of the pulse width modulation module.

In one embodiment, in the display panel, the driver chip further comprises a parasitic capacitance, the pulse amplitude modulation module is configured to output the strength corresponding to a compensation data signal when the pixel is not displayed according to a value of the parasitic capacitance, and the pulse width modulation module is configured to output the waveform corresponding to the compensation data signal when the pixel is not displayed according to the value of the parasitic capacitance.

In one embodiment, as shown in FIG. 1, the display panel includes a power supply terminal Vled, a light emitting unit LED, a driving transistor T1, a switching transistor T2. The driver chip 11 includes a scanning signal input module 111. The power terminal Vled is electrically connected to an anode of the light emitting unit LED. A cathode of the light emitting unit LED is electrically connected to a first electrode of the driving transistor T1. A second electrode of the driving transistor T1 is electrically connected to the ground GND. A gate of the driving transistor T1 is electrically connected to a second electrode of the switching transistor T2. A first electrode of the switching transistor T2 is electrically connected to the data signal input module 112. A gate of the switching transistor T2 is electrically connected to the scanning signal input module 111. Take the above driving circuit as an example, the data signal input module 112 is connected to the first electrode of the switch transistor T2. When the pixel needs to be displayed, the to-be-displayed brightness of the pixel is obtained, and then the to-be-displayed grayscale is determined by the to-be-displayed brightness of the pixel. The pulse width modulation module and the pulse amplitude modulation module respectively output the waveform and the strength of the data signal corresponding to the to-be-displayed grayscale. The data signal input module determines the data signal according to the waveform of the data signal and the strength of the data signal. Then the data signal input module inputs the data signal to the first electrode of the switch transistor, so that the light emitting unit can display the to-be-displayed brightness, and the display panel displays the to-be-displayed image.

The embodiment of the present disclosure takes the driver circuit including a switching transistor and a driving transistor as an example. However, in an actual circuit design, in order to achieve circuit stability and reduce the influence of parasitic capacitance of the circuit, a circuit with multiple transistors and multiple capacitors can be designed.

In one embodiment, as shown in FIG. 1, the display panel also includes a parasitic capacitance Cst. When there is parasitic capacitance, the strength of the data signal can be output by the pulse amplitude modulation module, and the waveform of the data signal can be output by the pulse width modulation module to compensate the drive circuit, thereby preventing parasitic capacitance from affecting the display effect.

As shown in FIG. 3, an embodiment of the present disclosure provides a driving method of a display panel, and the driving method of the display panel includes:
301, acquiring a to-be-displayed image of a display panel;
302, determining a to-be-displayed brightness of each pixel according to the to-be-displayed image of the display panel;
303, determining a display grayscale corresponding to the to-be-displayed brightness of each pixel according to the to-be-displayed brightness of each pixel;
304, determining a data signal corresponding to the display grayscale according to the display grayscale corresponding to the to-be-displayed brightness of each pixel;
305, determining a waveform and a strength corresponding to the data signal according to the data signal corresponding to the display grayscale; and
306, actuating a pulse width modulation module and a pulse amplitude modulation module of the driver chip to output the waveform corresponding to the data signal and the strength corresponding to the data signal respectively for displaying the to-be-displayed image.

An embodiment of the present disclosure provides a driving method of display panel. The to-be-displayed brightness of each pixel is determined after acquiring the to-be-displayed image of the display panel. The display grayscale corresponding to each pixel is determined according to the to-be-displayed brightness of each pixel. The data signal corresponding to the display grayscale according to the display grayscale of each pixel after acquiring the display grayscale of each pixel. The waveform and the strength corresponding to the data signal are determined according to the data signal. The pulse width modulation module and the pulse amplitude modulation module are actuated to output the waveform corresponding to the data signal and the strength corresponding to the data signal. When the display panel needs to display the image, by controlling the waveform of the data signal of each pixel and the strength of the data signal, each pixel can emit the corresponding light-emitting brightness. The light-emitting brightness of each pixel is controlled by the waveform of the data signal and the strength of the data signal, which can achieve more light-emitting brightness, making the display panel display more grayscales, thereby increasing the gradation level of the display panel and improving the display quality of the display panel.

In one embodiment, before the step of acquiring the to-be-displayed image of the display panel, first, determine the maximum display grayscale that the display panel can display, as well as the waveform of the data signal output by the pulse modulation module corresponding to each display grayscale and the strength of the data signal output by the pulse amplitude modulation module. When the display panel displays the image, the waveform of the data signal and the strength of the data signal are output through the pulse width modulation module and the pulse amplitude modulation module, so that the display panel displays the to-be-displayed image. The step includes acquiring the bits of the pulse width modulation module, acquiring the bits of the pulse amplitude modulation module, determining a maximum display grayscale of each pixel according to the bits of the pulse width modulation module and the bits of the pulse amplitude modulation module, and determining the waveform corresponding to the data signal outputted from the pulse width modulation module and the strength corresponding to the data signal outputted from the pulse amplitude modulation module at each display grayscale according to the maximum display grayscale of each pixel. For example, the number of bits of the pulse width modulation module is 7, and the number of bits of the pulse amplitude modulation module is 5, so that the maximum display grayscale of the pixel can be determined to be grayscale 4096. Then the waveform and the strength of the data signal corresponding to each display grayscale can be determined according to the maximum display grayscale of the pixel, the waveform of the data signal output by the pulse width modulation module, and the strength of the data signal output by the pulse amplitude modulation module. When the image is displayed on the display panel, the waveform of the corresponding data signal and the strength of the data signal can be output through the pulse width modulation module and the pulse amplitude modulation module to display the to-be-displayed image.

In one embodiment, in the step of determining the waveform corresponding to the data signal outputted from the pulse width modulation module and the strength corresponding to the data signal outputted from the pulse amplitude modulation module at each display grayscale according to the maximum display grayscale of each pixel, the type of the waveform corresponding to the data signal can be determined according to the bits of the pulse width modulation module, the type of the strength corresponding to the data signal can be determined according to the bits of the pulse amplitude modulation module, and the waveform corresponding to the data signal outputted from the pulse width modulation module and the strength corresponding to the data signal outputted from the pulse amplitude modulation module at each display grayscale can be determined according to the type of the waveform corresponding to the data signal and the type of the strength corresponding to the data signal. The step includes determining a type of the waveform corresponding to the data signal according to the bits of the pulse width modulation module, determining a type of the strength corresponding to the data signal according to the bits of the pulse amplitude modulation module, and determining the waveform corresponding to the data signal outputted from the pulse width modulation module and the strength corresponding to the data signal outputted from the pulse amplitude modulation module at each display grayscale according to the type of the waveform corresponding to the data signal and the type of the strength corresponding to the data signal. For example, the number of bits of the pulse width modulation module is 7, and the number of bits of the pulse amplitude modulation module is 5. By determining the waveforms of all the data signals output by the pulse width modulation module, and the strength of the data signals output by the pulse amplitude modulation module, data voltages of grayscale 4096 are obtained. Then the waveform of the data signal output by the pulse width modulation module and the strength of the data signal output by the pulse amplitude modulation module corresponding to each display grayscale are determined.

In one embodiment, before the step of acquiring the to-be-displayed image of the display panel, the parasitic capacitance of the pixels in the display panel can be compensated first. The step includes acquiring a value of a parasitic capacitance of the pixel when the pixel is not displayed, determining a waveform corresponding to a compensation data signal of the pixel and a strength corresponding to the compensation data signal of the pixel according to the value of the parasitic capacitance, and actuating the pulse width modulation module and the pulse amplitude modulation module to output the strength corresponding to the compensation data signal respectively.

In the embodiment of the present disclosure, the strength of the data signal output by the pulse amplitude modulation module can be multiple voltage data at equal intervals, or multiple voltage data at non-equal intervals, which is determined according to the actual display grayscale requirements.

According to the above embodiments:

The present disclosure provides a driver chip, a display panel, and a driving method thereof. The driver chip includes a data signal input module, a pulse width modulation module, and a pulse amplitude modulation module. The data signal input module is connected to a transistor of a pixel for inputting a data signal into the transistor. The pulse width modulation module is connected to the data signal input module for outputting a waveform corresponding to the data signal to the data signal input module according to a to-be-displayed brightness of the pixel. The pulse amplitude modulation module is connected to the data signal input module for outputting a strength corresponding to the data signal to the data signal input module according to a to-be-displayed brightness of the pixel. The data signal input module is configured to process the waveform corresponding to the data signal and the strength corresponding to the data signal to obtain the data signal after receiving the waveform corresponding to the data signal and the strength corresponding to the data signal. The embodiments of the present disclosure uses the pulse width modulation module and the pulse amplitude modulation module to control the waveform and strength of the data signal, respectively. Under the common control of the pulse width modulation module and the pulse amplitude modulation module, more display grayscales can be obtained, the to-be-displayed brightness of the light-emitting unit is larger, and the gradation level of the light-emitting unit is better. Moreover, the pulse amplitude modulation module can modulate the strength of the data signal and compensate the pixels, thereby improving the display quality of the display panel.

It is understandable that for those of ordinary skill in the art, equivalent replacements or changes can be made according to the technical solution of the present disclosure and its inventive concept. All these changes or replacements shall fall within the protection scope of the appended claims of the present disclosure.

What is claimed is:

1. A driver chip, comprising:
a data signal input module connected to a transistor of a pixel for inputting a data signal into the transistor;
a pulse width modulation module connected to the data signal input module for outputting a waveform corresponding to the data signal to the data signal input module according to a to-be-displayed brightness of the pixel; and
a pulse amplitude modulation module connected to the data signal input module for outputting a strength corresponding to the data signal to the data signal input module according to a to-be-displayed brightness of the pixel;
wherein the data signal input module is configured to process the waveform corresponding to the data signal and the strength corresponding to the data signal to obtain the data signal after receiving the waveform corresponding to the data signal and the strength corresponding to the data signal.

2. The driver chip according to claim 1, wherein a number of bits of the pulse width modulation module is equal to or greater than a number of bits of the pulse amplitude modulation module.

3. The driver chip according to claim 2, wherein the number of bits of the pulse width modulation module is 7, and the number of bits of the pulse amplitude modulation module is 5.

4. The driver chip according to claim 2, wherein the driver chip further comprises a grayscale module, the grayscale module is configured to determine a maximum display grayscale of the pixel according to the bits of the pulse width modulation module and the bits of the pulse amplitude modulation module and determine the waveform corresponding to the data signal outputted from the pulse width modulation module and the strength corresponding to the data signal outputted from the pulse amplitude modulation module at each display grayscale according to the maximum display grayscale of the pixel.

5. The driver chip according to claim 4, wherein the driver chip further comprises a signal acquisition module, the signal acquisition module is configured to determine a to-be-displayed grayscale of the pixel according to the to-be-displayed brightness of the pixel and send an acquisition signal to the grayscale module according to the to-be-displayed grayscale, and the grayscale module is configured to return the waveform corresponding to the data signal outputted from the pulse width modulation module and the strength corresponding to the data signal outputted from the pulse amplitude modulation module to the signal acquisition module after receiving the acquisition signal.

6. The driver chip according to claim 1, wherein a number of bits of the pulse amplitude modulation module is greater than a number of bits of the pulse width modulation module.

7. The driver chip according to claim 6, wherein the number of bits of the pulse amplitude modulation module is 8, and the number of bits of the pulse width modulation module is 7.

8. The driver chip according to claim 1, wherein the driver chip further comprises a parasitic capacitance, the pulse amplitude modulation module is configured to output the strength corresponding to a compensation data signal when the pixel is not displayed according to a value of the parasitic capacitance, and the pulse width modulation module is configured to output the waveform corresponding to the compensation data signal when the pixel is not displayed according to the value of the parasitic capacitance.

9. A display panel including a driver chip and pixels arranged in an array, wherein the driver chip comprises:
a data signal input module connected to a transistor of one of the pixel for inputting a data signal into the transistor;
a pulse width modulation module connected to the data signal input module for outputting a waveform corresponding to the data signal to the data signal input module according to a to-be-displayed brightness of the pixel; and
a pulse amplitude modulation module connected to the data signal input module for outputting a strength corresponding to the data signal to the data signal input module according to a to-be-displayed brightness of the pixel;
wherein the data signal input module is configured to process the waveform corresponding to the data signal and the strength corresponding to the data signal to obtain the data signal after receiving the waveform corresponding to the data signal and the strength corresponding to the data signal.

10. The display panel according to claim 9, wherein a number of bits of the pulse width modulation module is equal to or greater than a number of bits of the pulse amplitude modulation module.

11. The display panel according to claim 10, wherein the number of bits of the pulse width modulation module is 7, and the number of bits of the pulse amplitude modulation module is 5.

12. The display panel according to claim 10, wherein the driver chip further comprises a grayscale module, the grayscale module is configured to determine a maximum display grayscale of the pixel according to the bits of the pulse width modulation module and the bits of the pulse amplitude modulation module and determine the waveform corresponding to the data signal outputted from the pulse width modulation module and the strength corresponding to the data signal outputted from the pulse amplitude modulation module at each display grayscale according to the maximum display grayscale of the pixel.

13. The display panel according to claim 12, wherein the driver chip further comprises a signal acquisition module, the signal acquisition module is configured to determine a to-be-displayed grayscale of the pixel according to the to-be-displayed brightness of the pixel and send an acquisition signal to the grayscale module according to the to-be-displayed grayscale, and the grayscale module is configured to return the waveform corresponding to the data signal outputted from the pulse width modulation module and the strength corresponding to the data signal outputted from the pulse amplitude modulation module to the signal acquisition module after receiving the acquisition signal.

14. The display panel according to claim 9, wherein a number of bits of the pulse amplitude modulation module is greater than a number of bits of the pulse width modulation module.

15. The display panel according to claim 9, wherein the driver chip further comprises a parasitic capacitance, the pulse amplitude modulation module is configured to output the strength corresponding to a compensation data signal when the pixel is not displayed according to a value of the parasitic capacitance, and the pulse width modulation module is configured to output the waveform corresponding to the compensation data signal when the pixel is not displayed according to the value of the parasitic capacitance.

16. The display panel according to claim 9, wherein the display panel includes a power terminal, a light emitting unit, a driving transistor, and a switching transistor, the driver chip includes a scanning signal input module, the power terminal is electrically connected to an anode of the light emitting unit, a cathode of the light emitting unit is electrically connected to a first electrode of the driving transistor, a second electrode of the driving transistor is electrically connected to the ground, a gate of the driving transistor is electrically connected to a second electrode of the switching transistor, a first electrode of the switching transistor is electrically connected to the data signal input module, and a gate of the switching transistor is electrically connected to the scanning signal input module.

17. A driving method of display panel, comprising steps of:
acquiring a to-be-displayed image of a display panel;
determining a to-be-displayed brightness of each pixel according to the to-be-displayed image of the display panel;
determining a display grayscale corresponding to the to-be-displayed brightness of each pixel according to the to-be-displayed brightness of each pixel;
determining a data signal corresponding to the display grayscale according to the display grayscale corresponding to the to-be-displayed brightness of each pixel;
determining a waveform and a strength corresponding to the data signal according to the data signal corresponding to the display grayscale; and
actuating a pulse width modulation module and a pulse amplitude modulation module of the driver chip to output the waveform corresponding to the data signal and the strength corresponding to the data signal respectively for displaying the to-be-displayed image.

18. The driving method of display panel according to claim 17, wherein before the step of acquiring the to-be-displayed image of the display panel, the driving method further comprises steps of:
acquiring the bits of the pulse width modulation module;
acquiring the bits of the pulse amplitude modulation module;
determining a maximum display grayscale of each pixel according to the bits of the pulse width modulation module and the bits of the pulse amplitude modulation module; and
determining the waveform corresponding to the data signal outputted from the pulse width modulation module and the strength corresponding to the data signal outputted from the pulse amplitude modulation module at each display grayscale according to the maximum display grayscale of each pixel.

19. The driving method of display panel according to claim 18, wherein the step of determining the waveform corresponding to the data signal outputted from the pulse width modulation module and the strength corresponding to the data signal outputted from the pulse amplitude modulation module at each display grayscale according to the maximum display grayscale of each pixel comprises:
determining a type of the waveform corresponding to the data signal according to the bits of the pulse width modulation module;
determining a type of the strength corresponding to the data signal according to the bits of the pulse amplitude modulation module; and
determining the waveform corresponding to the data signal outputted from the pulse width modulation module and the strength corresponding to the data signal outputted from the pulse amplitude modulation module at each display grayscale according to the type of the waveform corresponding to the data signal and the type of the strength corresponding to the data signal.

20. The driving method of display panel according to claim 17, wherein before the step of acquiring the to-be-displayed image of the display panel, the driving method further comprises steps of:
acquiring a value of a parasitic capacitance of the pixel when the pixel is not displayed;
determining a waveform corresponding to a compensation data signal of the pixel and a strength corresponding to the compensation data signal of the pixel according to the value of the parasitic capacitance; and
actuating the pulse width modulation module and the pulse amplitude modulation module to output the strength corresponding to the compensation data signal respectively.
